(19) United States
(12) Patent Application Publication
(10) Pub. No.: US 2012/0096978 A1
(43) Pub. Date: Apr. 26, 2012

(54) BICYCLE STEM WITH INTEGRATED HEADLAMP ASSEMBLY

(75) Inventors: James Patrick Voshell, Castaic, CA (US); Douglas R. Domel, Santa Clarita, CA (US)

(73) Assignee: STEMLITE INC.

(21) Appl. No.: 12/909,059

(22) Filed: Oct. 21, 2010

(51) Int. Cl. B62K 21/12

(52) U.S. Cl. 74/551.8

(57) ABSTRACT

A bicycle stem for coupling a steer tube to bicycle handlebars has an integrated headlamp assembly which provides an effective, ovular beam spread to optimize use of available energy.

### I. FIELD OF THE INVENTION

The present invention relates generally to bicycle stems with integrated headlamp assemblies.

### II. BACKGROUND OF THE INVENTION

Bicycle stems are assemblies that couple the generally horizontal bicycle handlebars to the generally vertical steer tube which is connected to the front axle of the bicycle to turn the front wheel. To facilitate night riding, some bicycles are equipped with headlamps that can be bolted on to existing bicycle structure. As understood herein, such add-on headlamps can slip, vibrate, and become easily damaged as a result. Further, because of the vibration issue, add-on headlamps can lose adjustment and undesirably cast their beams off the centerline of the bicycle, i.e., somewhat to the side of the direction in which the rider is headed.

Moreover, unless the lamps are powered by a small generator engaged with a wheel of the bicycle (which places drag on the rider), batteries to power the lamps must be provided, further complicating the vibration/slippage issue with add-on headlamps. As also understood herein, battery-powered lamps should provide for as long of battery life as possible.

### SUMMARY OF THE INVENTION

As understood herein, the above problems may be addressed using a headlamp assembly integrated into a bicycle stem with individual lamps arranged to establish a light beam shape that better uses the energy available from batteries inside the stem. Energy efficiency is further augmented by using less current per luminous output than other bicycle headlamp assemblies by the selection of certain components in implementation.

Accordingly, a bicycle stem has a handlebar housing defining a handlebar channel configured to closely receive a handlebar of a bicycle therein. The stem also has a steer tube housing coupled to the handlebar housing and defining a steer tube channel configured to closely receive a steer tube of the bicycle therein, such that the stem couples the handlebar to the steer tube when the handlebar is received in the handlebar channel and the steer tube is received in the steer tube channel. A lamp receptacle is integrally formed in one of the housings and is oriented forward of the bicycle when the handlebar is received in the handlebar channel and the steer tube is received in the steer tube channel. Also, one or more lamps such as light emitting diodes (LED) are in the receptacle and are energizable to cast a beam of light forward of the bicycle when the handlebar is received in the handlebar channel and the steer tube is received in the steer tube channel.

In some embodiments a position switch on one of the housings can be manipulated by a person to cause the lamp to flash and to illuminate steadily without flashing. If desired, a power adjust switch on one of the housings can be manipulated to cause the lamp to illuminate in a high power mode and a low power mode. Plural lamps may be in the receptacle arranged in plural rows, and in example implementations the lamps can be arranged in a middle row of four lamps, a top row of two lamps, and a bottom row of two lamps. The lamps may provide an illumination cone having a vertical angle of at least twenty degrees (20°) relative to the bicycle and a horizontal angle of at least thirty degrees relative to the bicycle. A preferred LED is characterized by absolute maximum ratings as follows: thirty milliamps (30 mA) forward current, one hundred milliamps (100 mA) pulse forward current, five volts (5V) reverse voltage, one hundred five milliwatts (105 mW) power dissipation, thirty degrees Centigrade to eighty five degrees Centigrade (30° C.-85° C.) operating temperature.

In another aspect, an apparatus includes a bicycle stem for coupling a steer tube of a bicycle to handlebars of the bicycle. A headlamp assembly is integrated into the bicycle stem for providing an ovular beam spread to optimize use of available energy.

In another aspect, a method includes coupling a handlebar of a bicycle to a steer tube of the bicycle using a bicycle stem, and integrating a forward-oriented lamp into the stem. The lamp is energizable by a rider of the bicycle to illuminate space forward of the bicycle.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is perspective view of a bicycle stem in accordance with present principles;

FIG. 2 is another perspective view of the bicycle stem, showing bicycle handlebars and a bicycle steer tube in phantom and schematically showing a sensor;

FIG. 3 is an elevational view of an example headlamp assembly that is integrated into the bicycle stem of FIGS. 1 and 2;

FIGS. 4 and 5 are schematic diagrams respectively illustrating the vertical and horizontal spread of light provided by the assembly of FIG. 3;

FIG. 6 is an electrical schematic of an example circuit that may be used to power the headlamp assembly;

FIGS. 7 and 8 are perspective views of an alternate stem, with the tilt thumbscrew omitted for clarity; and

FIG. 9 is a side view of the stem shown in FIGS. 7 and 8 in transparency to illustrate a tilting mechanism for the lamps.

### DETAILED DESCRIPTION OF THE PREFERRED EMBODIMENT

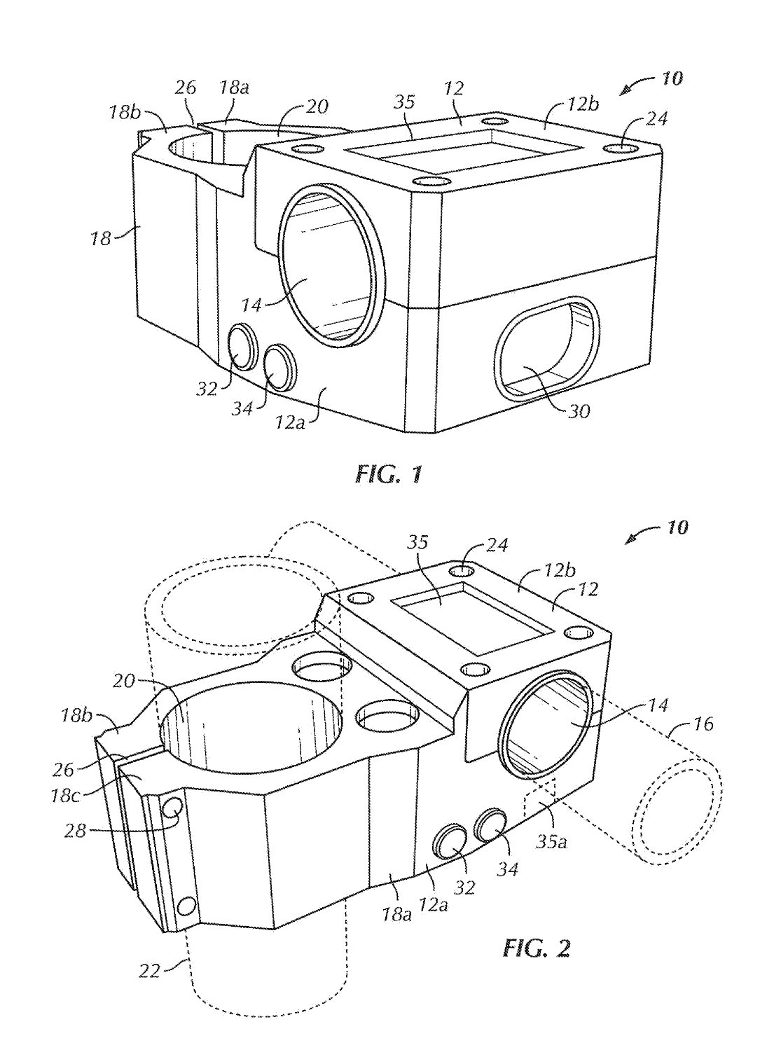

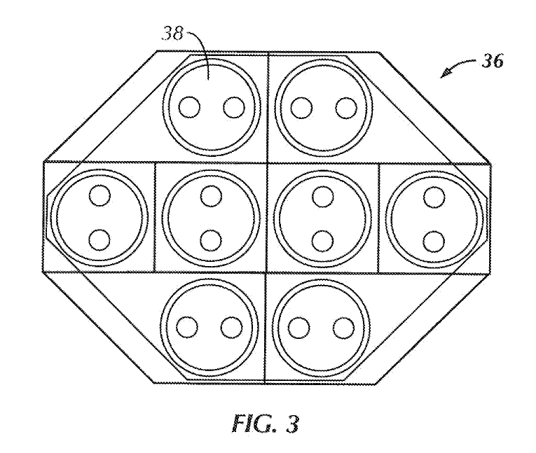

Referring initially to FIGS. 1 and 2, bicycle stem 10 has a handlebar housing 12 defining a handlebar channel 14 configured to closely receive a handlebar 16 of a bicycle therein. The stem 10 also has a steer tube housing 18 coupled to the handlebar housing 12 and defining a steer tube channel 20 configured to closely receive a steer tube 22 of the bicycle therein, such that the stem 10 couples the handlebar 16 to the steer tube 22 when the handlebar 16 is received in the handlebar channel 14 and the steer tube 22 is received in the steer tube channel 20.

In the embodiment shown, it will readily be appreciated that when mounted as intended in a bicycle frame, the handlebar channel 14 is oriented with its long axis substantially parallel to the ground while the steer tube channel 20 is oriented with its long axis substantially perpendicular to the ground. Both housings 12, 18 may be made of machined or cast metal such as but not limited to Aluminum. Example materials include 7068 heat treatable Aluminum, 440C stainless steel, etc.

The housings 12, 18 may include a respective unitary portion 12a, 18a that is made unitarily with the other portion 18a, 12a. The handlebar housing 12 may further include a portion 12b that is separate from its respective unitary portion 12a and that is coupled thereto by, e.g., vertically-oriented threaded fasteners received in vertically-oriented fastener holes 24. The threaded fasteners can be loosened as appropriate to enlarge the channel 14 to receive the bicycle handlebar 16 and then tightened toward the unitary portion 12a to clamp down on the handlebar.

On the other hand, the steer tube housing 18 may be unitary throughout, and may be formed with opposed vertical wall blocks 18b, 18c that are separated from each other by a vertical slit 26 as shown. The slit 26 is distanced from the unitary portion 18a of the steer tube housing 18 as shown and the wall blocks 18b, 18c likewise are distanced from the unitary portion 18a at the slit 26, but meld unitarily in to the unitary portion 18. The wall blocks 18b, 18c, and handlebar housing 12 may all be substantially parallelepiped-shaped as shown. Horizontally-oriented threaded fasteners are received in horizontally-oriented fastener holes 28 to engage the wall blocks 18b, 18c, and the fasteners may be loosened as appropriate to enlarge the channel 20 to receive the bicycle steer tube 22 and then tightened to clamp down on the steer tube, thereby tightly coupling the handlebar and steer tube together.

A lamp receptacle 30 (FIG. 1) is integrally formed in one of the housings 12, 18 and is oriented forward of the bicycle when the handlebar 16 is received in the handlebar channel 14 and the steer tube 22 is received in the steer tube channel 20. The receptacle 30 preferably is formed in whichever housing 12, 18 is forward of the other, which in the embodiment shown is the handlebar housing 12.

Also, one or more lamps such as light emitting diodes (LED) are in the receptacle 30 and are energizable to cast a beam of light forward of the bicycle when the handlebar 16 is received in the handlebar channel 14 and the steer tube 22 is received in the steer tube channel 20. Details of an example lamp assembly that is disposed in the receptacle 30 are set forth further below. Batteries to power the lamps may be supported in, e.g., the handlebar housing 12 and may be accessed by unscrewing the fasteners from the holes 24 and removing the housing portion 12b from the housing portion 12a that is integral with the steer tube housing 18, it being understood that the housing holding the batteries thus can be hollow.

In some embodiments a position switch 32 is on one of the housings, such as the handlebar housing 12 as shown, and can be manipulated by a person to cause the lamps in the receptacle 30 to flash and also to illuminate steadily without flashing. If desired, a power adjust switch 34 can also be provided on one of the housings, such as the handlebar housing 12 as shown, and can be manipulated to cause the lamps in the receptacle 30 to illuminate in a high power mode and also a low power mode. Further details of example non-limiting switches 32, 34 are set forth below in reference to FIG. 6. The switches 32, 34 may be toggle switches, lever-type switches, etc.

In some embodiments, a display 35 such as but not limited to a matrix-type liquid crystal display (LCD) may be supported on one of the housings 12, 18, in the embodiment shown, on the handlebar housing 12. The display 35 may present information from one or more sensors 35a (only a single sensor 35a shown in FIG. 2 for clarity) within one or both of the housings 12, 18. Without limitation, the sensor 35a may be a position sensor such as a global position satellite (GPS) sensor, a speed sensor, a heading sensor such as a compass, etc.

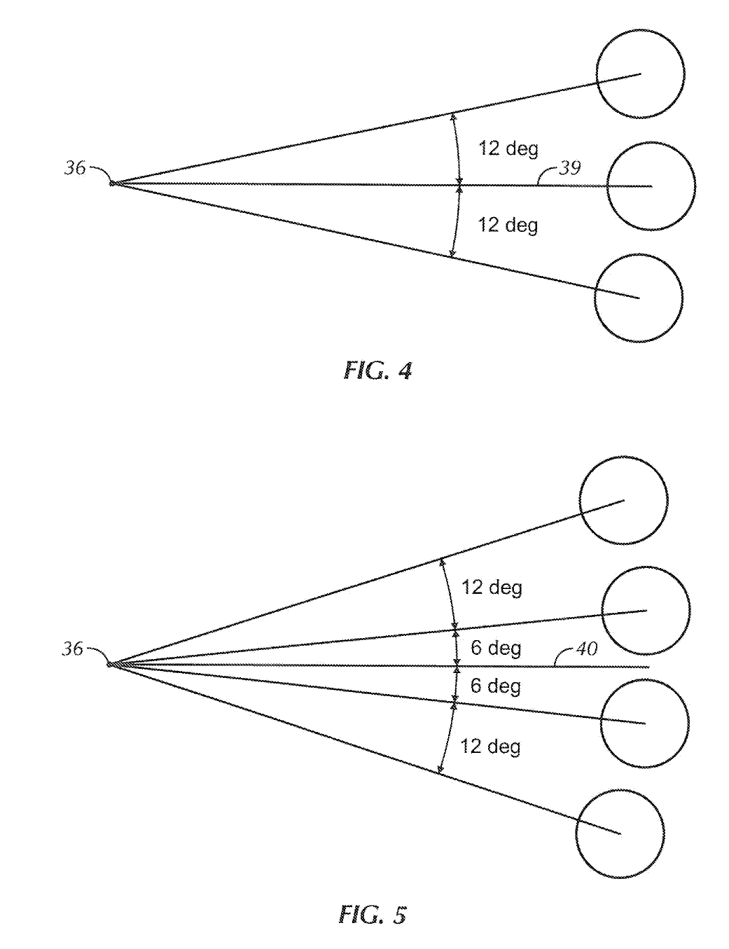

FIG. 3 shows a front elevational view of an example lamp assembly 36 that may be disposed within the receptacle 30 shown in FIG. 1. As shown, the assembly 36 includes plural lamps 38 that are arranged in plural rows. In the example shown the lamps 38 are arranged in a middle row of four lamps, a top row of two lamps, and a bottom row of two lamps, although other lamp configurations may be used such as having three lamps each in the top and bottom rows. As illustrated in FIG. 4, the lamps 38 in the assembly 36 are oriented achieve at least twenty degrees (20°) in vertical coverage as measured above and below the horizontal 39 and in the specific embodiment shown, the bottom row of lamps 38 casts a beam that forms an angle with the horizontal beam cast by the middle row of lamps 38 of minus twelve degrees (−12°) while the top row of lamps 38 casts a beam that forms an angle with the horizontal of twelve degrees (12°).

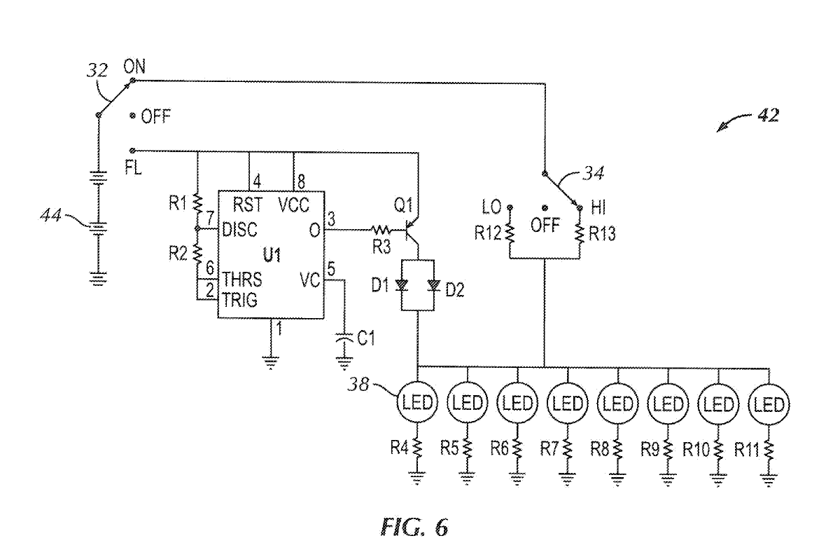

On the other hand, FIG. 5 shows that in the horizontal dimension, the lamps 38 of the assembly 36 are arranged and oriented to cover a horizontal angle of at least thirty degrees (30°) relative to the bicycle. In the specific embodiment shown, the two inner lamps 38 in the middle row and/or the two lamps 38 in the top and bottom rows shown in FIG. 3 are oriented at plus and minus six degrees (+6°), respectively from the fore-and-aft axis 40 of the stem 10. The two outer lamps 38 in the middle row of the assembly 36 shown in FIG. 3, in contrast, may form respective angles of plus and minus twelve degrees (+12°), respectively from the beam axes of the adjacent middle lamps. The combined vertical and horizontal beam spread results in an ovular overall beam that optimizes effective illumination coverage for the amount of battery power available.

A preferred LED is characterized by absolute maximum ratings as follows: thirty milliamps (30 mA) forward current, one hundred milliamps (100 mA) pulse forward current, five volts (5V) reverse voltage, one hundred five milliwatts (105 mW) power dissipation, thirty degrees Centigrade to eighty five degrees Centigrade (30° C.-85° C.) operating temperature. In one implementation, the LEDs 38 are Nichia white LEDs, model number NSPW500GS-K1 with the following additional characteristics (measured at 25° C.): forward voltage at forward current of 20 mA, typical 3.1V, maximum 3.5V; reverse current at 5V maximum 50 μA; luminous intensity in candela (cd) at a forward current of 20 mA is 33; chromacity coordinates in the x and y planes at 20 mA forward current are 0.31 and 0.32, respectively.

Also, luminous intensity for Rank W, V, and U at 20 mA forward current has respective minimum intensities of 31.0 cd, 22.0 cd, and 15.5 cd and respective maximum intensities of 44.0 cd, 31.0 cd, and 22.0 cd.

FIG. 6 shows an example circuit 42 incorporating the above-discussed electrical components. As shown, three preferably primary DC batteries 44, which may be Lithium batteries, may be placed in series with each other and connected to the position switch 32. The position switch 32 may have three positions, namely, on, off (which deenergizes the remaining components of the circuit 42), and “flashing”. In the “on” position steady (non-flashing or constant) current from the position switch 32 may flow to the power adjust switch 34, which has “low power mode”, “high power mode”, and “off” positions, although the “off” position may be omitted from the power adjust switch 34. In the “high power mode” position current flows from the power adjust switch 34 to a resistor R13 and thence to the LEDs 38 to illuminate the LEDs, each of which is grounded through a respective resistor R4-R11. On the other hand, in the “low power mode” position current flows from the power adjust switch 34 to a resistor R12 and thence to the LEDs 38 to illuminate the LEDs.

When the position switch 32 is in the flashing position, current flows through the switch 32 to pin 7 of a chip-based timer U1 through a resistor R1. Current also flows through a resistor R2 to pins 6 and 2 of the timer. Current from the position switch 32 also flows to pins 4 and 8 of the timer, and pin 5 of the timer is grounded through a grounding capacitor C1. Flashing current from pin 3 of the timer is connected through a resistor R3 to the base of a transistor Q1, the base of which is connected to the “flashing” pole of the position switch 32 and the emitter of which is connected through parallel diodes D1, D2 to the LEDs 38 to cause the LEDs to flash on and off when the position switch 32 is in the flashing position. The transistor Q1 provides sufficient current to drive the LEDs 38 because the timer U1 cannot source that much. The diodes D1, D2 prevent current from leaking back through the timer circuit when the position switch 32 is in the “on” (steady illumination) mode.

In the non-limiting example shown, all capacitors may be 5% and all resistors may be ⅛ watt, 1% except for R12 and R13, which may be ¼ watt, 1%. The timer U1 may be a TLC555CD chip and the transistor Q1 may be a MMBT4403 transistor. The resistor R1 may be a one million Ohm (1 MΩ) resistor and R2 may be a two hundred thousand Ohm (200KΩ) resistor. R4-R11 may be twenty five Ohm (25Ω) resistors, R12 may be twelve Ohm (12Ω) resistor, and R13 may be three and one-one hundredth Ohm (3.01Ω) resistor. R3 may be a six hundred eighty Ohm (680Ω) resistor. The timer U1 may cause the LEDs 38 to flash at a frequency of 3.0 Herz.

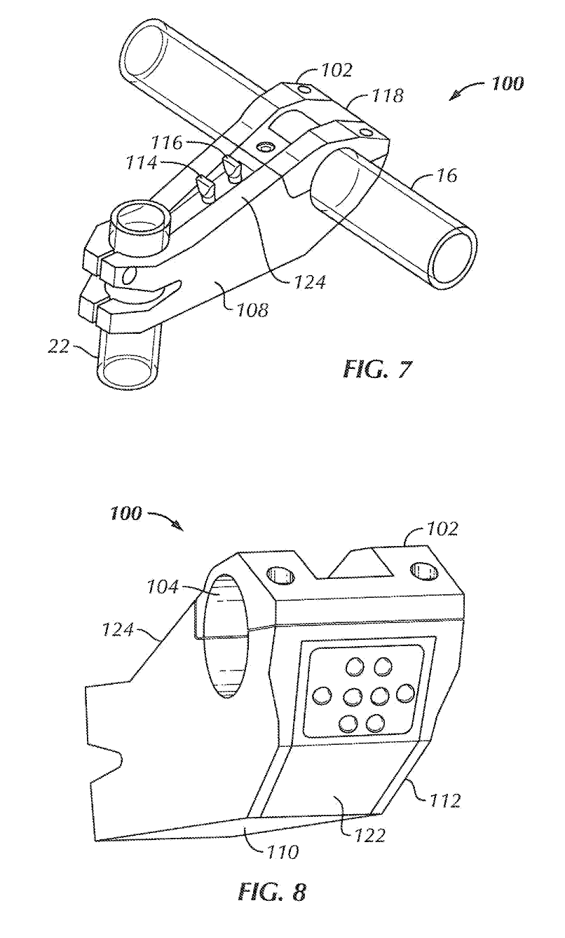

FIGS. 7 and 8 shown alternate stem 100 that in all substantial respects is identical to the stem shown in FIGS. 1-6, including being formed with a handlebar housing 102 defining a handlebar channel 104 configured to closely receive a handlebar 16 of a bicycle therein, a steer tube housing 108 coupled to the handlebar housing 102 and defining a steer tube channel 110 configured to closely receive a steer tube 22 of the bicycle therein, a lamp assembly 112, and position and power adjust switches 114, 116, all of which cooperate and function substantially as described above for their same-named counterpart components in FIGS. 1-6. However, the handlebar housing 102 in FIGS. 7-9 has a sleek, racy look established by an upper surface 118 that faces upwardly at an oblique angle to the horizontal merging into a middle surface 120 juxtaposed with the lamp array 112 and tilted down slightly from the vertical when mounted as intended, which in turn merges into a lower surface 122 that faces downwardly at an oblique angle to the horizontal. Also note that an upper surface 124 of the stem 100 slants upwardly from the steer tube mount 108 to the handlebar mount 102.

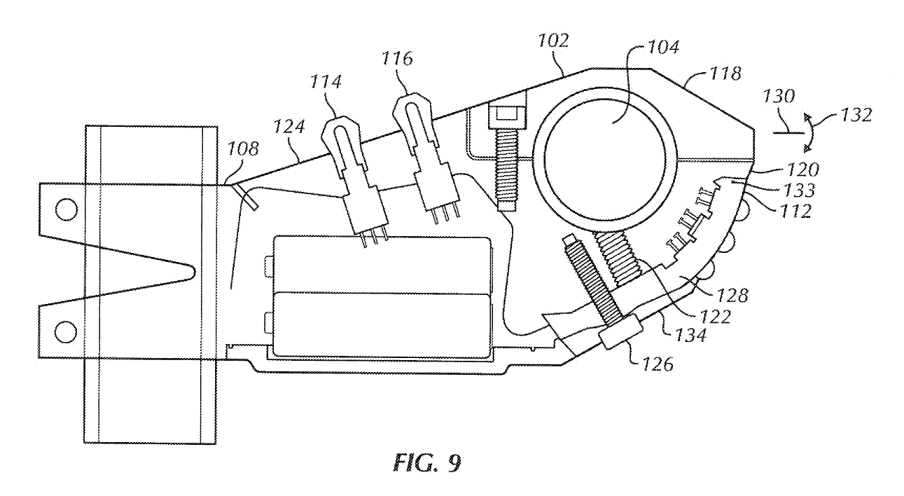

FIG. 9 shows a tilting mechanism such as but not limited to a thumbscrew 126 that is threadably engaged with a housing such as the handlebar housing 102 described above. A portion of the thumbscrew 126 extends beyond the housing so that a person can turn the thumbscrew. The thumbscrew 126 abuts against a lamp array board 128 that supports the array 112. It is to be understood that the board 128 may be a circuit board that bears the lamp array discussed above. When the thumbscrew is turned the board 128 with lamps is caused to tilt about the horizontal 130 as indicated by the arrows 132 at a pivot connection or point 133 near its upper end to raise and lower the elevation of the light beam generated by the lamps on the board. A spring 134 disposed in compression against the inside surface of the board 128 as shown provides counterforce to the thumbscrew. Tightening the thumbscrew compresses the spring and causes the board to tilt down, lowering the beam from the lamps. Loosening the thumbscrew allows the spring to expand, causing the board to tilt up, raising the beam from the lamps. In one example embodiment the board with lamps can tilt from plus six degrees above the horizontal to minus six degrees below the horizontal (±6°).

In lieu of the thumbscrew, a thumbwheel or other structure may be coupled to the array board to tilt the lamps.

While the particular BICYCLE STEM WITH INTEGRATED HEADLAMP ASSEMBLY is herein shown and described in detail, it is to be understood that the subject matter which is encompassed by the present invention is limited only by the claims.

What is claimed is:

1. Bicycle stem comprising:
handlebar housing defining a handlebar channel configured to closely receive a handlebar of a bicycle therein;
steer tube housing coupled to the handlebar housing and defining a steer tube channel configured to closely receive a steer tube of the bicycle therein such that the stem couples the handlebar to the steer tube when the handlebar is received in the handlebar channel and the steer tube is received in the steer tube channel;
a lamp receptacle integrally formed in one of the housings and being oriented forward of the bicycle when the handlebar is received in the handlebar channel and the steer tube is received in the steer tube channel; and
at least one lamp in the receptacle and energizable to cast a beam of light forward of the bicycle when the handlebar is received in the handlebar channel and the steer tube is received in the steer tube channel.

2. The bicycle stem of claim 1, wherein the lamp is a light emitted diode (LED).

3. The bicycle stem of claim 1, comprising a position switch on one of the housings, the position switch being manipulable by a person to cause the lamp to flash, the position switch being further manipulable by a person to cause the lamp to illuminate steadily without flashing.

4. The bicycle stem of claim 1, comprising a power adjust switch on one of the housings, the power adjust switch being manipulable by a person to cause the lamp to illuminate in a high power mode, the power adjust switch being further manipulable by a person to cause the lamp to illuminate in a low power mode.

5. The bicycle stem of claim 1, comprising plural lamps in the receptacle arranged in plural rows.

6. The bicycle stem of claim 5, wherein the lamps are arranged in a middle row of four lamps, a top row of two lamps, and a bottom row of two lamps.

7. The bicycle stem of claim 5, wherein the lamps provide an illumination cone having a vertical angle of at least twenty degrees (20°) relative to the bicycle and a horizontal angle of at least thirty degrees relative to the bicycle.

8. The bicycle stem of claim 1, wherein the LED is characterized by absolute maximum ratings as follows: thirty milliamps (30 mA) forward current, one hundred milliamps (100 mA) pulse forward current, five volts (5V) reverse voltage, one hundred five milliwatts (105 mW) power dissipation, thirty degrees Centigrade to eighty five degrees Centigrade (30° C.-85° C.) operating temperature.

9. Apparatus comprising:
bicycle stem for coupling a steer tube of a bicycle to handlebars of the bicycle; and
a headlamp assembly integrated into the bicycle stem and providing an ovular beam spread to optimize use of available energy.

10. The apparatus of claim 9, wherein the bicycle stem comprises:
a handlebar housing defining a handlebar channel configure to closely receive the handlebar of a bicycle therein;
steer tube housing coupled to the handlebar housing and defining a steer tube channel configured to closely receive the steer tube of the bicycle therein such that the stem couples the handlebar to the steer tube when the handlebar is received in the handlebar channel and the steer tube is received in the steer tube channel;
a lamp receptacle integrally formed in one of the housings and being oriented forward of the bicycle when the handlebar is received in the handlebar channel and the steer tube is received in the steer tube channel.

11. The assembly of claim 10, wherein the headlamp assembly includes at least one lamp.

12. The assembly of claim 11, comprising a position switch on one of the housings, the position switch being manipulable by a person to cause the lamp to flash, the position switch being further manipulable by a person to cause the lamp to illuminate steadily without flashing.

13. The assembly of claim 11, comprising a power adjust switch on one of the housings, the power adjust switch being manipulable by a person to cause the lamp to illuminate in a high power mode, the power adjust switch being further manipulable by a person to cause the lamp to illuminate in a low power mode.

14. The assembly of claim 11, comprising plural lamps in the receptacle arranged in plural rows.

15. The assembly of claim 14, wherein the lamps are arranged in a middle row of four lamps, a top row of two lamps, and a bottom row of two lamps.

16. The assembly of claim 14, wherein the lamps provide an illumination cone having a vertical angle of at least twenty degrees (20°) relative to the bicycle and a horizontal angle of at least thirty degrees relative to the bicycle.

17. The assembly of claim 11, wherein the lamp is a light emitting diode (LED) characterized by absolute maximum ratings as follows: thirty milliamps (30 mA) forward current, one hundred milliamps (100 mA) pulse forward current, five volts (5V) reverse voltage, one hundred five milliwatts (105 mW) power dissipation, thirty degrees Centigrade to eighty five degrees Centigrade (30° C.-85° C.) operating temperature.

18. Method comprising:
coupling a handlebar of a bicycle to a steer tube of the bicycle using a bicycle stem; and
integrating a forward-oriented lamp into the stem, the lamp being selectively energizable by a rider of the bicycle to illuminate space forward of the bicycle.

19. The method of claim 18, comprising:
facilitating a rider causing the lamp to flash; and
facilitating the rider causing the lamp to illuminate without flashing.

20. The method of claim 19, comprising:
facilitating a rider causing the lamp to illuminate in a low power mode; and
facilitating a rider causing the lamp to illuminate in a high power mode.
